(19) United States
(12) Patent Application Publication
(10) Pub. No.: US 2023/0257601 A1
(43) Pub. Date: Aug. 17, 2023

(54) RUBBER SURFACE COATING SYSTEM

(71) Applicant: No More Smells Limited, Norfolk (GB)

(72) Inventor: John E. Walls, Kentwood, MI (US)

(73) Assignee: No More Smells Limited, Norfolk (GB)

(21) Appl. No.: 17/674,150

(22) Filed: Feb. 17, 2022

(51) Int. Cl. C09D 7/65; C09D 7/20; C09D 7/62; C09D 7/63; C08K 5/00

(52) U.S. Cl. CPC C09D 7/65; C09D 7/20; C09D 7/62; C09D 7/63; C08K 5/0025; C08K 2201/019

(57) ABSTRACT

A composition which when applied to a tire or other rubber surface, facilitates the release of dirt, debris, and other foreign contaminants and prevents their adhesion. The composition consists of a binder functionalized to be able to crosslink, a silane or siloxane oligomer capable of being crosslinked, a crosslinking agent, a catalyst, and an environmentally suitable solvent system. The coating may be sprayed, brushed, dipped either with or without an applied electrical potential.

### TECHNICAL FIELD

The present invention relates to the field of improving wear, traction, and cleaning of tires, tracks, and other moving rubber surfaces.

### BACKGROUND

Rubber surfaces such as large truck tires, conveyor belts, rubber tools, utensils and the like are prone to having various forms of contamination adhere to the surface in at undesirable manner. This at times is due to the surface porosity, configuration, or texture wherein particulates may become mechanically integrated into the surface. Under different circumstances foreign matter may adhere to the surface due to the surface being both hydrophilic and oleophilic. Large trucks used for mining and hauling lose traction when soil, stone and small rocks become lodged in the tread. Conveyor belts lose capacity when material being conveyed adheres to the surface and reduces the capacity of the system. In such instances, costs of operation increase given increased time for conveyance, increased cost for cleaning due to down time.

There are various know methods to impart release characteristics to myriad surfaces, particularly rubber and rubber-like compositions. However, the known technologies fall short in performance in comparison to the present invention.

U.S. Pat. No. 4,427,831 teaches the use of an ordinary rubber and a powder of norbornene polymer which hardens at service temperatures on ice and softens at higher temperatures and which does not lose its shape as a powder when heated during curing or shaping, wherein the ordinary rubber is a butadiene rubber, a styrene-butadiene rubber, an isoprene, rubber, or a natural rubber.

U.S. Pat. No. 4,918,142 teaches a rubber composition which comprises a rubber component containing a block copolymer consisting essentially of a block A and a block B, obtained by conducting polymerization of an aromatic vinyl compound and a conjugated diene compound in a hydrocarbon solvent in the presence of an organolithium initiator and modifying with a coupling agent, and satisfying the following conditions (A) to (E). The method of operation improves traction through the surface composition but fails to utilize the benefit of the tread groove surface area.

U.S. Pat. No. 5,530,040 teaches the use of a traction composition comprised of a lignin-based phenolic compound, a silicone resin, a rosin, and a suitable carrier. The traction composition may be applied to the surfaces of wet or dry vehicle tires to impart anti-slip properties thereto. In accordance with the present invention, the anti-slip properties have increased durability so that the tires have good traction over a longer distance of travel. In that traction comes from the coating on the surface contacting the pavement, the benefit is lost after several miles.

U.S. Pat. No. 5,681,874 teaches a tire tread that is composed of three basic elastomers, namely, medium cis 1,4-polybutadiene rubber, isoprene/butadiene copolymer and natural cis 1,4-polyisoprene rubber and which is reinforced with either carbon black or a combination of carbon black and silica reinforcing fillers. The describe art is non-analogous in that an introduced roughness is employed which does not utilize the benefit of the tread groove surface area.

U.S. Pat. No. 5,967,211 teaches a tire with a rubber tread reinforced with silica and containing one or more additives designed to aid ice traction for the tread. Such additive is selected from at least one of (i) at least one organic fiber having hydroxyl groups on the surface thereof selected from cellulose fibers and wood fibers and (ii) small, hollow, spherical ceramic particles having silanol groups on the surface thereof and containing silica as predominant particulate reinforcement and other traditional rubber compound ingredients. In particular, a coupler is used to couple the silica as well as the said additive(s) to the elastomer(s) in the tire tread composition. The describe art is non-analogous in that it fails to recognize the use of tread groove surface area.

U.S. Pat. No. 6,228,908 teaches the use of diene polymers or copolymers having improved balance between raw polymer viscosity and mixed compound viscosity, useful in tire tread compositions having highly balanced wet traction, rolling resistance, and traction in ice and snow. The improvement is directed at the tire composition and fails to recognize the benefit of tread groove surface area.

U.S. Pat. No. 6,303,688 teaches a rubber composition for tire tread, which can provide a tire having low decrease in abrasion resistance and balanced performance of traction property, braking property and cornering property. The rubber composition for tire tread is obtained by mixing at least one rubber component selected from the group consisting of a natural rubber, an isoprene rubber and a butadiene rubber, silica, a silane coupling agent and a powdered article containing cellulose material. Such a composition may have improved handling on regular surfaces, but there is no suggestion traction would be improved on wet, snow or ice surfaces.

U.S. Pat. No. 8,772,388 teaches the use of acrylic latex copolymers having a high Tg with silane and siloxane to provide water proofing, chemical resistance, scratch and mar resistance, resistance to hot tire pickup, while minimizing the possibility of osmotic blistering and being able to use any desired cosolvent to produce a one-coat, clear, high gloss coating, or sealant.

U.S. 20020037950 teaches a rubber composition for tire and a pneumatic tire in which the rubber composition used improves steering performance on snowy and icy roads. The rubber composition for tire contains paper relative the weight of a rubber component. The paper is newspaper waste. The invention utilizes the composition of the tire rather than taking advantage of the surface area of the tire grooves.

U.S. 20050070681 teaches a composition comprising a polymer and methods of using the composition to increase the traction of an article of manufacture on an icy surface. The polymer can be a silicate polymer, a plancheite-derived polymer, a pinacol polymer, an indanol polymer, a phenol polymer, or an m-xylylene polymer. The composition is effective only for the portion of the tire in contact with the pavement and fails to utilize the surface area in the tread grooves.

U.S. 20200332130 teaches a composition comprised of a binder polymer, a high molecular weight silane, or siloxane oligomer or polymer(s) and a suitable delivery system permitting easy application, fast drying and excellent adhesion. When applied to a tire or other surface, where itis desirable for snow and ice not to adhere, promotes release of snow and ice from the tire tread or surface for improved traction and performance.

### SUMMARY OF THE INVENTION

A method and coating composition for preventing the adhesion of dirt, debris, and particulate matter on rubber surfaces for improved performance comprising a mixture of at least one functionalized elastomeric polymer and a functionalized silicone compound, and a crosslinking compound, all solubilized in a solvent system in which the functionalized elastomeric polymer and functionalized silicone compound are cross linked in situ by said crosslinking compound, said composition being free of any fluorine compounds.

### DESCRIPTION OF THE PREFERRED EMBODIMENT

The preferred embodiment coatings have extended durability and wear characteristics, excellent traction due to surfaces with minimal debris buildup, longer service time and remarkable reduction in cleaning time. The improved performance over having no coating is achieved by incorporating hydrophobic compounds into durable elastomeric polymers by crosslinking them in situ on the coated substrate with effective crosslinking compounds. Using a solvent system for delivery of a diluted active system, the coating can penetrate into the macro and micro porosity of the substrate being coated. After evaporation of the solvent system, the reactive components can crosslink and become an integral part of the substrate. The remaining coating is one that is hydrophobic with functionalized silicone compounds fully integrated into the coating system, and without the addition of any fluorine additives.

All percentages, parts and ratios used herein are based upon the total weight of the compositions, unless otherwise specified. All molecular weights as used herein are weight average molecular weights expressed as grams per mole, unless otherwise specified herein. The term polymer, as used herein, includes materials whether made by polymerization of one type of monomer or two or more types of monomers (i.e., copolymer, terpolymer, etc.).

### Functionalized Elastomeric Polymer

The functionalized elastomeric polymer component represents the bulk of the solid portion of the coating. The polymer must have inherent adhesion to rubber, rubber compounds and articles comprising rubber. The rubber may be natural or synthetic. The elastomeric polymer must have a Tg (glass transition point) of less than ambient temperature. A preferred polymer has a Tg of less than −20° C. A more preferred polymer has a Tg of less than −35° C. The most preferred polymer has a Tg of less than −50° C.

The preferred polymers are selected from the general classes of polyester, polyether, polyvinyl acetate, polyvinyl acetal, butylene terephthalate, epoxy vinyl esters, polyvinyl chloride, chlorinated polyvinyl chloride, polyisobutylene, polystyrene, vinyl acetal copolymers, vinyl ester copolymers, vinyl acetate copolymers, polyurethanes, bisphenol A epoxies, bisphenol A isophthalate, bisphenol A terephthalate, hydrophobically modified cellulose, polyacrylonitrile, polybutadiene, polyaramids, nylon 6, nylon 66, nylon 610, polyacrylate, polymethacrylate, analogous co-, ter-, tera-, etc. polymers, aliphatic hydrocarbon resins (C5, C9, etc.), methacrylonitrile butadiene styrene, UV curable resins, photopolymers and the like.

More preferred polymers include but are not restricted to classes of polyester, polyether, polyvinyl acetate, polyvinyl acetal, butylene terephthalate, epoxy vinyl esters, polyisobutylene, polystyrene, vinyl acetal copolymers, vinyl ester copolymers, vinyl acetate copolymers, hydrophobically modified cellulose, polyacrylonitrile, polybutadiene, nylon 6, nylon 66, nylon 610, polyacrylate, polymethacrylate, analogous co-, ter-, tera-, etc. polymers, methacrylonitrile butadiene styrene, UV curable resins, photopolymers and the like.

Most preferred polymers include but are not restricted to classes of polyester, polyether, polyvinyl acetate, polyvinyl acetal, butylene terephthalate, polyisobutylene, polystyrene, vinyl acetal copolymers, vinyl ester copolymers, vinyl acetate copolymers, polyacrylonitrile, polybutadiene, polyacrylate, polymethacrylate, analogous co-, ter-, tera-, etc. polymers, methacrylonitrile butadiene styrene, and the like.

The functional groups are selected from the classes of hydroxyl, amine, vinyl, epoxy, mercapto, acryl and/or isocyanate groups. The functionality may be mono-, di-, tri-, tetra- and poly.

Examples of functionalized polymers that are commercially available include but are not limited to acrylates such as Joncryl from BASF, Acrylite from Roehm Chemicals, Copro and Paranol from H. B. Fuller, Marcoa from Macroocean, and the like. Useful acetal polymers include but are not limited to Butvar from Eastman Chemical, Mowitol by Kuraray, Winlite by Chang Chung Petrochemicals, PVB Resin from IMPAG, and the like. Useful polyester polymers include but are not limited to Elancast from Elantas, Crastin from DuPont, Teraloy from Teknor Apex Company, Hytrel from Toray Industries and the like. Useful acetate polymers include but are not limited to Vinnex and Vinnapas from Wacker, Vagh Resin from Anhui Derun Import and Export, Ateva from Celanese, Respsol from Clark and Walker and the like. One skilled in the art will recognize which polymer candidates having the designated glass transition point (Tg) and functional group will be suitable as the binder polymer is the desired elastomeric coating.

### Functionalized Silicon Compound

The preferred silicon polymers are selected from the general classes of trimethylated silica, trimethylphenyl silsesquiloxane, 3-amino ethyl diphenylsiloxane with phenyl silsesquiloxane, cyclophenylsiloxane with dimethicone copolymer, cetyldiglyceryl (trimethylsiloxy) silylethyl dimethicone, 3-octylheptamethyl trisiloxane, hexafunctional silicone resin, dimethylphenylmethylphenyl silicone, phenylpropyl silsesquioxane, lauryl PEG tris(trimethyl siloxy) silylethyl dimethicone, polysilane, polydimethylsilane, polysiloxane, polydimethylsiloxane, and the like.

More preferred polymers include but are not restricted to classes of trimethylphenyl silsesquiloxane, cyclophenylsiloxane with dimethicone copolymer, 3-octylheptamethyl trisiloxane, hexafunctional silicone resin, dimethylphenylmethylphenyl silicone, polysilane, polydimethylsilane, polysiloxane, polydimethylsiloxane, and the like.

Most preferred polymers include but are not restricted to classes of cyclophenylsiloxane with dimethicone copolymer, 3-octylheptamethyl trisiloxane, hexafunctional silicone resin, polysilane, polydimethylsilane, polysiloxane, polydimethylsiloxane, and the like.

The functional groups are selected from the classes of hydroxyl, amine, vinyl, epoxy, mercapto, acryl and/or isocyanate groups. The functionality may be mono-, di-, tri-, tetra- and poly.

Examples of functionalized silicon compounds that are commercially available include but are not limited to Silmer series, Silamine series and Silube series from Siltech Corporation, the AMS, DBE and DMS series from Gebest, Inc., functional PDMS from Alfa chemistry, Dowsil series from Dow Chemicals, and the like. One skilled in the art will recognize which silicon-based candidates having the desired physical characteristics and functional group will be suitable as the silicon additive in the optimal elastomeric coating.

### Crosslinking Compound

As a class, isocyanate compounds are the most useful for achieving crosslinking of the elastomeric polymer and the silicone compound through the functional groups on each. The most advantageous isocyanates are diisocyanates, triisocyanates and tetraisocyanates. Monofunctional increases branching but does not advantageously crosslink or significantly build molecular weight. Although greater than penta isocyanates may be used with merit, stearic hinderance reduces the final coating quality.

Preferred isocyanates are selected from the general class of toluene diisocyanate, hexamethylene diisocyanate, isophorone diisocyanate, 4,4′-diphenyl methane diisocyanate, 1,2,3-tris(isocyanatoethylthio) propane, tris(p-isocyanatophenyl) thiophosphate, naphthyene-1.5-diisocyanate, cycloaliphatic diisocyanate, 1,3,5-tri(hexylisocyanate) triazine, and the like.

Examples of crosslinking agents that are commercially available include but are not limited to Tolonate from Vencorex, Mondur, Desmodur and Imprafix from Covestro AG, TDI from Parchem, Teracure from Pflaumer brothers, and the like.

### Solvent System

The elastomers and silicone compounds heretofore described are soluble in myriad solvents. The proper selection of a solvent system is dependent on the rubber substrate, specific functionalized elastomeric polymer, functionalized silicon compound and crosslinking agent. Generally, there are four classes of solvents: Hydrocarbons such as mineral spirits, toluene, xylene, and numerous others. Oxyhydrocarbons such as ethers, glycol ethers, aldehydes, esters, and the like. Halogenated hydrocarbons such as chloromethane, chloroethane, tetrachloroethane and the like. There are those based on nitrogen sulfur and other elements such as dimethylformamide, dimethyl sulfoxide, N-methyl pyrrolidone and the like. One skilled in the art would recognize the proper solvent system based upon the rubber substrate, end application, coating components and end application.

### Additional Ingredients

Other addenda such as catalysts, surfactants, stabilizers, and the like may be optionally and advantageously added to achieve specific results.

For surfaces difficult to wet, surfactants may be employed to reduce surface tension for more effective coverage and surface penetration. Most tires can be effectively coated with solutions having a surface tension of 35—dynes/cm². Certain rubber compositions and durometer require surface tensions of<20 dynes/cm².

Depending upon the end use and drying conditions, it may be desired to add a catalyst to accelerate crosslinking. Again, one skilled in the art would recognize the preferred approach based upon the end application.

Stabilizers may be used in the event the formulated product shows separation tendencies.

### Method of Making

One Part System

If no catalyst is included to accelerate the drying of the coating when applied, the coating can be formulated as a one part system. The first step is to dissolve the functionalized elastomeric polymer and the functionalized silicon compound in the preferred solvent system. The ratio of polymer to silicon compound is 1:1 to 1:200. More preferred is 1:5 to 1:150 and most preferred is 1:10 to 1:75.

The cross linking agent is then blended into the above solution in a cross linker to polymer and silicon blend of 1:1 to 1:100. More preferred is 1:10 to 1:80 and most preferred is 1:20 to 1:50. The product is then ready for use.

Two Part System

If a catalyst is used to accelerate drying of the product when it is applied, a two part system is used. As above, the first step is to dissolve the functionalized elastomeric polymer and the functionalized silicon compound in the preferred solvent system in the ratios discussed above. This formulation is the first part of the system.

The second part of the system is made by dissolving or blending the crosslinking agent with a catalyst in another preferred solvent system. The amount of catalyst used is a function of how quickly one would like the system to cure/dry when it is applied. The amount of crosslinking agent used is such that when the two parts of the system are blended, the ratio of the cross linker to polymer and silicon blend is 1:1 to 1:100. More preferred is 1:10 to 1:80 and most preferred is 1:20 to 1:50.

The same solvent system may be used as for the first part. A different solvent system could be used as long as the two solvent systems with their respective components can be combined without separation or other immiscibility difficulties.

Use of the Coating System

When using a two part system, both parts of the system are blended, and the blended parts are applied as a single coating by painting, dipping, spraying or other conventional means of application. The catalyzed crosslinking process begins immediately.

When a one part system is used, it is applied as indicated above. The crosslinking process begins as the system starts to dry.

Whether using a two part or a one part system, it is important to apply the coating in less than an hour so that the solvent may evaporate, and the crosslinking may continue in situ.

Of course, it is understood that the above are preferred embodiments and that other changes, alterations and variations of the preferred embodiments may be used without departing from the scope of the invention as set forth in the appended claims.

1. A coating composition for preventing the adhesion of dirt, debris, and particulate matter on rubber surfaces for improved performance comprising a mixture of at least one functionalized elastomeric polymer, a functionalized silicon compound, a crosslinking compound all solubilized in a solvent system, and being free of any fluorine compounds.

2. The coating composition of claim 1 in which the ratio of functionalized silicon compound to the functionalized elastomeric polymer is 1:20 to 1:2 and the combination of functionalized silicon compound and functionalized elastomeric polymer is dissolved in 2% to 30% solvent by weight.

3. The coating composition of claim 1 in which the combined ratio of functionalized elastomeric polymer and functionalized silicon compound to crosslinking compound is 60:1 to 10:1 and the combination of functionalized silicon compound and functionalized elastomeric polymer and the crosslinking compound is dissolved in 2% to 30% solvent by weight.

4. The coating composition of claim 1 in which the ratio of functionalized silicon compound to the functionalized elastomeric polymer is 1:15 to 1:1 and the combination of functionalized silicon compound and functionalized elastomeric polymer is dissolved in 5% to 20% solvent by weight.

5. The coating composition of claim 1 in which the combined ratio of functionalized elastomeric polymer and functionalized silicon compound to crosslinking compound is 45:1 to 15:1 and the combination of functionalized silicon compound and functionalized elastomeric polymer and the crosslinking compound is dissolved in 5% to 20% solvent by weight.

6. The coating composition of claim 5 in which said functionalized silicon compound is one that will not evaporate or sublime under ambient conditions.

7. The coating composition of claim 6 in which said functionalized silicon compound is one that has a vapor pressure<0.1 mm Hg

8. The coating composition of claim 7 in which said functionalized silicon compound is one that has a viscosity of greater than about 200 cps.

9. The coating composition of claim 8 in which said functionalized silicon compound is one that has a viscosity of greater than about 800 cps.

10. The coating composition of claim 9 in which said functionalized silicon compound is one that has a viscosity of greater than about 1200 cps.

11. The coating composition of claim 5 in which said functionalized elastomeric polymer is one that will not evaporate or sublime under ambient conditions.

12. The coating composition of claim 5 in which said functionalized silicon compound, or blend, is one that has a Tg of<−20° C.

13. The coating composition of claim 12 in which said functionalized silicon compound, or blend, is one that has a Tg of<−35° C.

14. The coating composition of claim 13 in which said functionalized silicon compound, or blend, is one that has a Tg of<−50° C.

15. The coating composition of claim 5 in which said solvent is a blend of two or more solvents which fully dissolve the functionalized elastomeric polymer (s), a functionalized silicone compound (s), and crosslinking compound (s), are rapidly drying compatible with and capable of wetting all surfaces to which the coating may be applied.

16. The coating composition of claim 15 in which said solvent also incorporates at least one surfactant.

17. The coating composition of claim 5 in which said functionalized elastomeric polymers are selected from the general class of polyester, polyether, polyvinyl acetate, polyvinyl acetal, butylene terephthalate, epoxy vinyl esters, polyvinyl chloride, chlorinated polyvinyl chloride, polyisobutylene, polystyrene, vinyl acetal copolymers, vinyl ester copolymers, vinyl acetate copolymers, polyurethanes, bisphenol A epoxies, bisphenol A isophthalate, bisphenol A terephthalate, hydrophobic ally modified cellulose, polyacrylonitrile, polybutadiene, polyaramids. nylon 6, nylon 66, nylon 610, polyacrylate, polymethacrylate, analogous co-, ter-, tera-, etc. polymers, aliphatic hydrocarbon resins (C5, C9, etc.), methacrylonitrile butadiene styrene, UV curable resins, photopolymers and the like.

18. The coating composition of claim 17 in which said functionalized elastomeric polymers are functionalized with hydroxyl, amine, vinyl, epoxy, mercapto, acryl and/or isocyanate groups.

19. The coating composition of claim 18 in which the functional groups may be mono-, di-, tri-, tetra- and poly.

20. The coating composition of claim 5 in which said functionalized silicon compounds are selected from the general class of trimethylated silica, trimethylphenyl silsesquiloxane, 3-amino ethyl diphenylsiloxane with phenyl silsesquiloxane, cyclophenylsiloxane with dimethicone copolymer, cetyldiglyceryl (trimethylsiloxy) silylethyl dimethicone, 3-octylheptamethyl trisiloxane, hexafunctional silicone resin, dimethylphenylmethylphenyl silicone, phenylpropyl silsesquioxane, lauryl PEG tris(trimethyl siloxy) silylethyl dimethicone, polysilane, polydimethylsilane, polysiloxane, +polydimethylsiloxane, and the like.

21. The coating composition of claim 20 in which said functionalized silicone compounds are functionalized with hydroxyl, amine, vinyl, epoxy, mercapto, acryl and/or isocyanate groups.

22. The coating composition of claim 21 in which the functional groups may be mono-, di-, tri-, tetra- and poly.

23. The coating composition of claim 5 in which the crosslinking compound (s) is selected from the general class of toluene diisocyanate, hexamethylene diisocyanate, isophorone diisocyanate, 4,4′-diphenyl methane diisocyanate, 1,2,3-tris(isocyanatoethylthio)propane, tris(p-isocyanatophenyl) thiophosphate, naphthylene-1.5-diisocyanate, cycloaliphatic diisocyanate, 1,3,5-tri(hexylisocyanate) triazine, and the like.

24. The coating composition of claim 23 in which the isocyanate groups may be mono-, di-, tri-, tetra- and poly.

25. The coating composition of claim 1 which is made in two parts for blending at the time of application of the coatings: part one comprising said functionalized elastomeric polymer and said functionalized silicon compound dissolved in a first portion of said solvent system; a second part comprising a catalyst and said crosslinking compound.

26. A method of making a coating composition for preventing the adhesion of dirt, debris, and particulate matter on rubber surfaces for improved performance comprising: dissolving a functionalized elastomeric polymer and a functionalized silicon compound in a solvent system in a ratio of polymer to silicon compound of 1:1 to 1:200; then blending a cross linking compound into said solvent solution in a cross linker to polymer and silicon blend of 1:1 to 1:100.

27. A method of making a coating composition for preventing the adhesion of dirt, debris, and particulate matter on rubber surfaces for improved performance comprising: dissolving a functionalized elastomeric polymer and a functionalized silicon compound in a first solvent system in a ratio of polymer to silicon compound of 1:1 to 1:200; dissolving a functionalized elastomeric polymer and a catalyst into a second solvent system; maintaining said first and second solvent systems separately until the coating is to be applied to a surface: the ratio of said cross linker to said polymer and silicon blend is 1:1 to 1:100 when said two parts are blended.
